(19) United States
(12) Patent Application Publication
(10) Pub. No.: US 2007/0063395 A1
(43) Pub. Date: Mar. 22, 2007

(54) Two-stage injection molding apparatus and method using interior fluid pressure

(76) Inventors: Werner Lang, Ergersheim (DE); Markus Meier, Markt Nordheim (DE)

Correspondence Address: MCNAIR LAW FIRM, P.A., P.O. BOX 10827, GREENVILLE, SC, 29603-0827, US

(21) Appl. No.: 11/520,867

(22) Filed: Sep. 14, 2006

(30) Foreign Application Priority Data
Sep. 16, 2005 (DE) 102005044384.2

(51) Int. Cl. B29C 33/40

(52) U.S. Cl. 264/572; 264/219; 425/557

(57) ABSTRACT

The present invention concerns a two stage, injection molding apparatus and method for the manufacture of molded parts having operational steps of filling of a plasticized, workable material into a first mold introducing a volume of compressed gas and/or a liquid under pressure into the said workable material in order to expand this workable material and increase its volume to create a first molded part, and forcing surplus material out of the first mold into a second mold in order to form in a second molded part in the second cavity.

### BACKGROUND OF THE INVENTION

The present invention is directed to a two stage, interior fluid pressure molding apparatus and method for the manufacture of master mold parts, especially for the fabrication of motor vehicle rear view mirrors or parts thereof.

For the manufacturing of master mold parts with exceptionally thin walls, such as are exemplified by housings, carriers, or linkages of motor vehicle mirrors, interior fluid pressure methods are known. In regard to these known methods, initially a plastic, workable material, for example, a heated thermoplastic, is encapsulated within a closed hollow cavity of a casting mold. Subsequently, a volume of fluid under pressure is introduced into this cavity which hydraulically bears against the workable material causing the same to bond against the cavity walls. This forms an interior cavity within the reshaped material. Following the solidification of the molded material, a thin-walled master part can be removed.

For the cooling of the mold and achieving a shortened cycle duration, DE 199 29 7.00 A1 proposes a generic, two stage interior fluid pressure method, by which initially a volume of pressurized gas is introduced for the creation of the interior cavity as above. This gas is then removed and the material is subjected to the introduction of a liquid volume under pressure. In order to accomplish a build-up of a sufficient pressure during the introduction of the gas the mold must remain as a closed system. Thus, it becomes necessary to inject into the existing hollow cavity as a prior operation, a quantity of the workable material necessary to compose the finished master mold part. Considerations regarding shrinkage, sprue construction, wall thicknesses and the like require, as a rule, an empirical adjustment of this quantity. Such adjustments not only prolong the required preparation time for the manufacture, but also unnecessarily waste additional material.

To this end, a prior German patent application 10 2004 020 579.5, proposes that a reservoir be provided into which surplus material can be diverted. The surplus material is lost, which has the effect of degrading the economy of the two-stage fluid interior pressure method. Since, due to the thin wall thickness and the principally large hollow cavity, this loss of material occurs repeatedly in each manufacturing operation.

As an alternate, DE 195 18 963 A1, which discloses a single stage gas injection method, proposes forcing the surplus, while still meltable material, back into the attendant plasticizer from which it may be recycled into additional master mold parts. However, in the two stage method taught by DE 199 29700 A1, these residual materials are already reduced in temperature, because of the inevitable cooling caused by the injected liquid volume. The result is that undesirable phase changes cause shrinkage and/or embedded solids in the operation of replasticization and recycling, Consequently, attempts at replasticization or using multiple replasticized material lead to inhomogeneities marring the resulting production.

Thus, an object of the present invention is to improve the known two stage, fluid pressure interior pressure method, as set forth in DE 199 29 700 A1, in such a manner that the method can be economically operated and, further, counter to the known method of DE 195 18 963 A1, the raw material need be plasticized only once, so that the disadvantages accompanying multi-replasticizing are avoided.

Another object of the present invention is to make available an apparatus for the execution of a method, which will carry out the above mentioned improvement.

### SUMMARY OF THE INVENTION

The above objectives are accomplished according to the present invention by providing a two stage, interior pressure method, and apparatus for injection molding comprising the steps of introducing a plastic, workable material into a first mold cavity, introducing a gas volume (gas, steam, etc.) under pressure into this material for the formation of a hollow space, and the input of a liquid volume under pressure into this hollow space in order to enlarge the space and to create a first master mold part.

In accord with the invention, surplus, plastic workable material is not rejected as scrap into a reservoir or a recycling system for replasticizing. Rather, by means of the volumes of the gas and/or the liquid, the surplus is ejected into a second mold (i.e., cavity) in order that a second master mold part will be created.

In this way, it becomes advantageously possible, that the previously lost material from a two stage liquid interior pressure method is brought into economical use and is available for the formation of a second master mold part and the said material need not be replasticized for this purpose. This is an energy saving step, since otherwise it would have been necessary to preheat the material again. All together, in this way, an available method is presented whereby the original two stage fluid interior pressure method can be employed in an efficient and economical manner.

As a plastic, workable material, preferably a meltable, thermoplastic is used and the liquid volume would be a volume of water.

During the introduction of the plastic, workable material into the first mold cavity, and/or during the application of the gas volume in the first mold cavity, it is possible that the mold can be a part of a completely closed system. The first mold can be separate from the second mold, or can be especially made to be able to communicate therewith.

The present invention encompasses, on this account, the possibility that the first mold cavity is initially a closed system during the filling of the plastic, workable material and/or during the subsequent introduction of the gas volume. This closure advantageously enables a rapid build-up of the desired hollow space, since the material has not yet altered itself away from its primary injected shape. The pressure of the gas volume can now hydraulically press the said plastic, workable material on an equal basis against the interior walls of the first mold. Then, only after the first mold is filled and/or the hollow space is built up within the first mold by means of the gas o volume, is a connection established to the second mold cavity. By means of the subsequently introduced liquid volume, again on the equalized basis, the hollow space of the first mold is enlarged and therewith the first master mold part is completely constructed, while the surplus, plastic workable material residing in the first mold is thereby ejected into the second mold to form a master mold part. In an especially fortunate manner, the first and the second molds communicate only during the introduction of the material, so that residual air present in the first mold can be expelled into the second mold and subsequently out of this second mold into the atmosphere. Subsequently, the closed connection is opened, so that the gas volume can quickly create a hollow space, without loss of pressure within the second mold.

Another embodiment of the present invention is the first and the second molds are continually in communication. In this case, first the plastic, workable material is injected into the first mold. When this is complete, then surplus material, which is obviously not needed in the first mold, can be transferred into the second mold by means of subsequently introduced gas or steam volumes. By means of post-introduced liquid volume, the residual excess material is pushed out of the first mold and into the second mold to allow second master mold parts to be completely created. Advantageously, in this operation, no additional throttling apparatus is necessary for control between the first and the second molds.

Another embodiment of the present invention is that initially, the communication between first and the second molds is such that surplus plasticized workable material can pass through a connection from the first mold into the second mold. Subsequently, this connection is closed and the liquid volume acts only for an enlargement of the hollow space in the first mold, during which the second mold is not subjected to any effect from the introduction of the liquid volume.

The interconnection between the first and the second mold corresponds to the plasticized, workable material, which is to be treated. This interconnection can be designed so that the surplus material can only be expelled by pressure from the first mold into the second mold. In the same manner, this is controllable, so that, for example, during the introduction of the gas volume, constantly increasing amounts of the material are pressed into the second mold.

Advantageously, it is possible that a direct pressure casting part i.e., an extrusion device, can be designed for a second master mold part. This can be made in respect to the continuously expelled surplus, plasticized, workable material, whereby the length of the pressure cast object would be related to the quantity of the surplus material. This arrangement has the advantage, that the total, introduced, plasticized workable material need be only roughly estimated at the start. Furthermore, such a pressure casting could have thicker wall construction and a lesser quality than the first master mold part. In this case, accordingly, for the manufacture of the pressure casting part, the already determined expelled material is to be used.

In a similar manner, it is possible that the second master mold part can be made by means of an internal fluid pressure (gas volume) injected into the second mold so that, in the second hollow space, an additional, i.e., greater, hollow space can be made. In this case, it is advantageous to provide an integral reservoir in connection with the second mold into which residual material can be diverted.

In order to assure the presence of the plasticized workable material during the build-up of both master mold parts, it is possible that the surplus material, ejected from the first mold can be subjected to heat during its passage through the connection device between the first and second molds.

### DESCRIPTION OF THE DRAWINGS

The construction designed to carry out the invention will hereinafter be described, together with other features thereof.

FIG. 1 is a schematic view illustrating an apparatus for carrying out the method according to the present invention after the introduction of the plasticized, workable material;

FIG. 2 is a schematic view of the apparatus of FIG. 1 during the injection of the gas volume according to the present invention;

FIG. 3 is a schematic view of the apparatus of FIG. 2 during the introduction of the liquid volume according to the present invention; and

FIG. 4 is a schematic view of the apparatus in accord with FIG. 1 with respective completed first and second master mold parts according to the present invention.

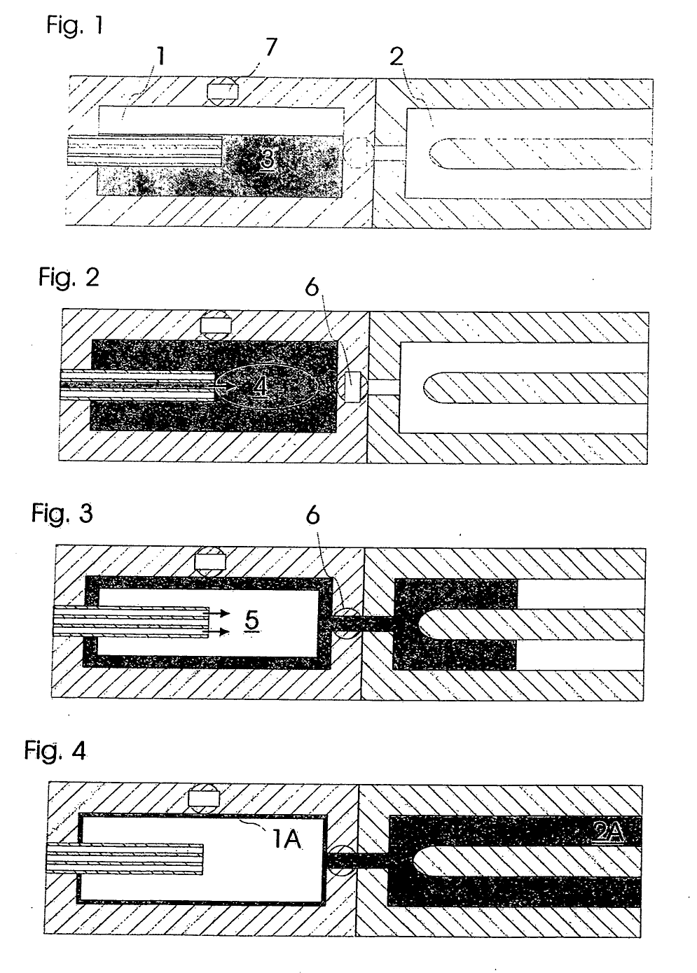

### DESCRIPTION OF A PREFERRED EMBODIMENT

Referring now in more detail to the drawings, the invention will now be described in more detail.

Figure shows schematically an apparatus for the carrying out of the invented method. This apparatus encompasses an injection mold A having a first mold cavity 1 and a second mold cavity 2. In the embodiment described above it is possible that both mold cavities can be separated from one another by a closed connection 6. In another embodiment (not shown) which, in the following explanation, corresponds to the described design, both molds 1, 2 are continually in communication with one another. In this case, one can also consider that connection 6 is always open.

It may be seen, that into the first mold 1, a plasticized, workable material 3 had formerly been introduced into the embodiment example through a feed valve 7. The valve was subsequently closed and remains closed during the ensuing method. This material introduction partially fills the first mold cavity 1. A complete filling of the said first mold cavity is also a possibility.

In the second step of the method, depicted in FIG. 2, a gas volume 4 (in FIG. 2 of a lighter gray color) is introduced. In the pictured embodiment example, this can be nitrogen under a pressure in excess of atmospheric pressure. Instead of a gas, it is possible that a steam volume could be injected

By the presence of gas or steam under pressure, the plasticized, workable material 3 is uniformly pressed against the entire interior wall surfaces of the first mold cavity 1, whereby a gas filled, hollow space is created. In the shown embodiment example, the connection 6 remains closed. Since the first mold cavity is originally only partially filled with the material 3, atmospheric air which is resident in the first mold cavity is first subjected to the pressure of the gas volume 4. To accomplish this, the first mold cavity possesses a corresponding exit opening (not shown). In this exit opening to a communicating mold, it is possible that this air and the material are simultaneously partially diverted into the second mold cavity 2. Advantageously, no additional outlet opening is necessary.

In the third step, as depicted in FIG. 3, following the suction removal of the gas in hollow space 4, a liquid volume 5 is injected into the just created hollow space and the connection 6 is opened. The liquid volume 5, which is under pressure, expands the hollow space of the first mold cavity and impels additional material into the second mold cavity 2. This simultaneously cools down the material 3 now present in the first mold cavity 1, so that the first master mold part 1A completes its creation.

In the next presented alternative embodiment, the introduced liquid volume forces the surplus material 3 still further into the second mold cavity. Second mold cavity 2, into which the surplus material 3 is forced, shapes this material in a direct extrusion device to a theoretically endless length, in accord with the quantity of surplus material 3.

Since the thermoplastic melt 3 is already considerably cooled by the water 5, it is possible that both the first as well as the second master mold parts 1A, 2A, respectively, can be rapidly removed, which plays a part in reducing the cycling times. Since the surplus material, which is forced out of the first mold 1 (and in the case of thin-walled first master mold parts, this can represent a large piece-count proceeds to a complete consumption of the described material in the manufacture of the endless direct extrusion press 2A. Thus, no raw material is lost as scrap.

The manufacturing of thick walled extrusion products is especially without problems, in that the plasticized workable material 3, upon its being pressed into the second mold 2 is already beginning to harden, i.e., to be cooled. Advantageously, it is possible, for example, that the connection 6 between the first and the second mold cavities can be heated. If this is done, then the pressurized, surplus material is subjected to the input of heat and the final cure slowed or indeed made complete.

In one embodiment, an apparatus of the present invention accommodates a two stage fluid, interior pressure method for the manufacture of master mold parts (1A, 2A) with the steps of introducing a plasticized, workable material 3 in a first mold cavity 1. Next, a gas volume (4) is injected under pressure into this material (3) for the build-up of a hollow-space and/or the introduction of a liquid volume (5) under pressure into the hollow space. This builds the hollow space into its final maximum internal dimensions and create a first master mold part (1A). Next, the excess plasticized, workable material is forced by the gas volume and/or the liquid volume out of the first mold into a second mold cavity (2) in order to form a second master mold part (2A) in the second mold.

While a preferred embodiment of the invention has been described using specific terms, such description is for illustrative purposes only, and it is to be understood that changes and variations may be made without departing from the spirit or scope of the following claims.

What is claimed is:

1. A two stage, interior fluid pressure method for the manufacture of master mold parts comprising the steps:
a) introducing of a plasticized, workable material into a first cavity;
b) injecting one of a gas and steam volume under pressure into the said material for the formation of a hollow space;
c) introducing a liquid volume under pressure into said hollow space to create a first master mold part; and
d) forcing surplus, workable material out of said first cavity into a second cavity by means of one of a volume of gas, steam or liquid volume to create a second master mold part in said second cavity.

2. The method of claim 1 wherein said plasticized, workable material comprises a thermoplastic material.

3. The method of claim 1 including blocking access to said second cavity during the filling of the plasticized workable material into the first cavity during the introduction of said one of a gas and steam volume into the first cavity.

4. The method of claim 1 including providing open fluid communication between said first cavity and said second cavity during the introduction of the plasticized, workable material in the first cavity and/or during the introduction of said one of a gas and steam volume into the said first cavity.

5. The method of claim 1 including forming said second master mold part during an extrusion process.

6. The method of claim 1 including separately introducing of a volume of one of a gas, steam and water into said second cavity to create a second hollow space in said second cavity.

7. The method of claim 1 wherein said liquid volume is composed of water.

8. The method of claim 1 including supplying heat to said surplus, workable material, which is expelled out of the first cavity.

9. An apparatus for implementing a two stage, injection molding method comprising:
a first mold cavity for the creation of a first master mold part;
means for introducing a plasticized, workable material into said first mold cavity;
means for introducing one of a pressurized gas and steam volume into said material for the creation of a hollow space;
means for introducing a liquid volume under pressure into this said hollow space in order to enlarge the said hollow space and to form the first master mold part;
a second mold cavity for creating a second master mold part;
a connection between said first and second cavities through which a surplus of plasticized material is forced from said first cavity into said second cavity by one of a gas, steam, and liquid volume in order to create a second master mold part in said second cavity.

10. The apparatus of claim 10 including means for selectively opening and closing said connection between said first and second mold cavities.
